(19) United States
(12) Patent Application Publication
(10) Pub. No.: US 2025/0065747 A1
(43) Pub. Date: Feb. 27, 2025

(54) SERVER

(71) Applicant: TOYOTA JIDOSHA KABUSHIKI KAISHA, Toyota-shi (JP)

(72) Inventor: Yuya YAMAUCHI, Nagoya-shi (JP)

(73) Assignee: TOYOTA JIDOSHA KABUSHIKI KAISHA, Toyota-shi (JP)

(21) Appl. No.: 18/668,553

(22) Filed: May 20, 2024

(30) Foreign Application Priority Data
Aug. 25, 2023 (JP) 2023-137453

(51) Int. Cl. B60L 53/62; B60L 58/24

(52) U.S. Cl. CPC B60L 53/62; B60L 58/24; B60L 2240/545; B60L 2260/56

(57) ABSTRACT

A server includes a communication unit (acquisition unit) that acquires temperature information about a battery of an electrified vehicle, and a processor. The processor predicts the temperature transition of the battery in a meeting period during which an electric power supply-demand adjustment request from an electric power grid (electric power network) can be met, based on at least the temperature information. The processor estimates an hour zone in the meeting period during which the temperature of the battery is in the range of a non-restrictive temperature zone (a temperature zone in which transmitted electric power is restricted), based on the temperature transition. The processor sets an hour zone during which the electrified vehicle executes electric power transmission in response to the electric power supply-demand adjustment request, based on the estimated hour zone.

### CROSS-REFERENCE TO RELATED APPLICATION

This application claims priority to Japanese Patent Application No. 2023-137453 filed on Aug. 25, 2023, incorporated herein by reference in its entirety.

### BACKGROUND

### 1. Technical Field

The present disclosure relates to a server.

### 2. Description of Related Art

Japanese Unexamined Patent Application Publication No. 2021-158838 discloses a vehicle that performs charging or discharging depending on a demand response in an electric power system network.

### SUMMARY

There is a temperature zone of a battery that is suitable for charging and discharging of a vehicle. In the case where the temperature of the battery is away from this temperature zone, the charging electric power and discharging electric power of the vehicle are sometimes restricted. In the case where the vehicle meets the demand response (an electric power supply-demand adjustment request based on the electric power amount in the electric power network) in a state where the charging electric power and the discharging electric power are restricted, the charging electric power amount or discharging electric power amount (transmitted electric power amount) is sometimes unable to reach an agreed amount in the demand response.

The present disclosure has been made for solving the above problem, and an object of the present disclosure is to provide a server that can restrain the transmitted electric power amount from the electrified vehicle from being unable to reach the agreed amount in the demand response.

A server according to an aspect of the present disclosure is a server that manages electric power transmission capable of being performed by at least one electrified vehicle, the electric power transmission including at least one of charging from an electric power network and discharging to the electric power network, the server including: an acquisition unit that acquires temperature information about a battery of the at least one electrified vehicle; and a processor. Transmitted electric power in the electric power transmission is not restricted in a case where the temperature of the battery of the at least one electrified vehicle is in a range of a non-restrictive temperature zone. The processor predicts the temperature transition of the battery in a meeting period based on at least the temperature information, the meeting period being a period during which an electric power supply-demand adjustment request from the electric power network is capable of being met, and estimates an hour zone in the meeting period based on the temperature transition, the hour zone being a period during which the temperature of the battery is in the range of the non-restrictive temperature zone. The processor sets an hour zone during which the at least one electrified vehicle executes the electric power transmission in response to the electric power supply-demand adjustment request, based on the estimated hour zone.

In the server according to the aspect of the present disclosure, as described above, the hour zone during which the electric power transmission is executed in response to the electric power supply-demand adjustment request is set based on the hour zone during which the temperature of the battery is in the range of the non-restrictive temperature zone. Thereby, it is possible to execute the electric power transmission in the hour zone during which the transmitted electric power of the battery is not restricted. As a result, it is possible to restrain the transmitted electric power amount from the electrified vehicle from being unable to reach the agreed amount in the demand response.

In the server according to the above aspect, the processor may predict the temperature transition of the battery based on at least one of the distance between the current place of the at least one electrified vehicle and a destination at which the electric power transmission is scheduled to be executed, the transition of air temperature between the current place and the destination, and the transition of the air temperature at the destination. In this configuration, it is possible to easily presume the temperature transition of the battery, using information about the traveling distance of the electrified vehicle based on the above distance and the above transition of the air temperature.

In the server according to the above aspect, the processor may perform a control to send a temperature adjustment command for the battery to the at least one electrified vehicle, in a case where a transmitted electric power amount in the electric power transmission by the at least one electrified vehicle is less than an agreed amount in the electric power supply-demand adjustment request and where the transmitted electric power of the at least one electrified vehicle is restricted in at least a part of the meeting period. In this configuration, the temperature of the battery is adjusted, and thereby it is possible to improve the degree of the restriction of the transmitted electric power (to shorten a time during which the restriction is performed). As a result, it is possible to easily cause the transmitted electric power amount to be equal to or more than the agreed amount.

In this case, the at least one electrified vehicle may include a plurality of electrified vehicles in which the transmitted electric power is restricted. For each of the plurality of electrified vehicles, a restriction amount of the transmitted electric power may be larger as the temperature of the battery is more away from the non-restrictive temperature zone. The processor may perform a control to send the temperature adjustment command preferentially to an electrified vehicle that is of the plurality of electrified vehicles and in which the restriction amount of the transmitted electric power is small. In this configuration, the temperature adjustment command is sent preferentially to the electrified vehicle in which the restriction amount of the transmitted electric power is small, and thereby it is possible to cause a temperature adjustment amount based on the temperature adjustment command to be relatively small.

In the server that sends the above temperature adjustment command to the electrified vehicle, the at least one electrified vehicle may include a plurality of electrified vehicles in which the transmitted electric power is restricted. The processor may perform a control to send the temperature adjustment command preferentially to an electrified vehicle that is of the plurality of electrified vehicles and in which the degradation level of the battery is low. In this configuration, it is possible to restrain the temperature adjustment command from being sent to an electrified vehicle in which the degradation level of the battery is relatively high. As a result, it is possible to restrain a further degradation of the battery of the electrified vehicle in which the degradation level of the battery is relatively high.

With the present disclosure, it is possible to restrain the transmitted electric power amount from the electrified vehicle from being unable to reach the agreed amount in the demand response.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a system according to an embodiment;

FIG. 2 is a diagram showing the relation between the upper limit of transmitted electric power and the temperature of a battery;

FIG. 3 is a first diagram showing an example of the relation between the temperature of the battery and hour;

FIG. 4 is a second diagram showing an example of the relation between the temperature of the battery and the hour;

FIG. 5 is a diagram showing a sequence of the system according to the embodiment; and

FIG. 6 is a diagram showing a modification of step S12 in FIG. 5.

### DETAILED DESCRIPTION OF EMBODIMENTS

An embodiment of the present disclosure will be described below in detail with reference to the drawings. In the figures, identical or corresponding parts are denoted by identical reference characters, and descriptions thereof will be not repeated.

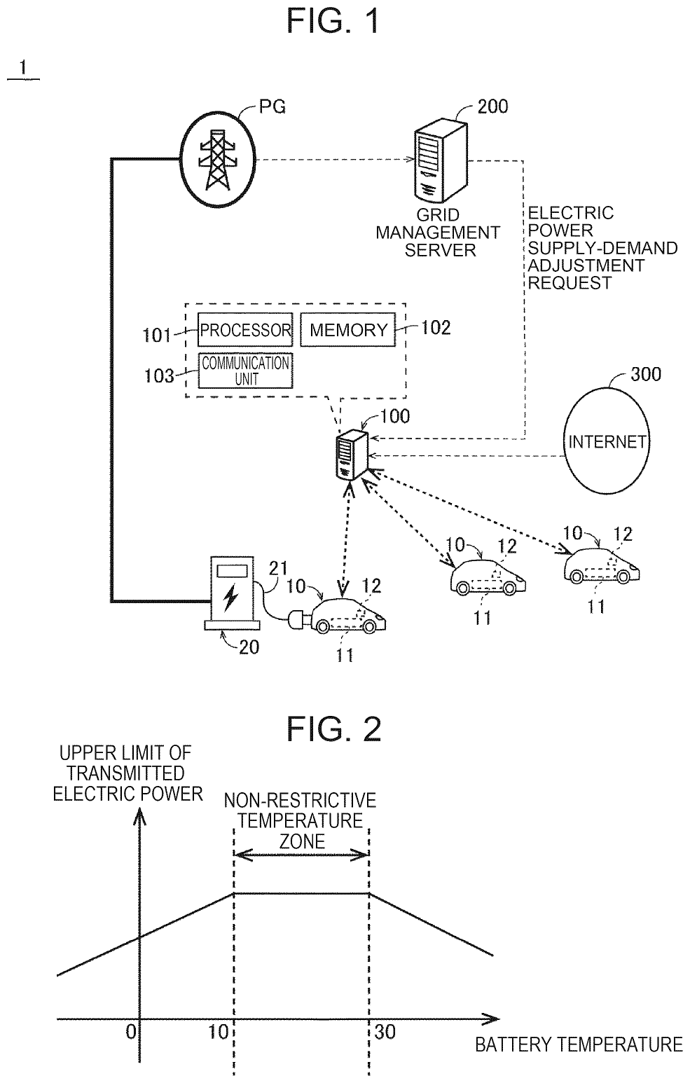

FIG. 1 is a diagram showing the configuration of a system 1 according to the embodiment. The system 1 includes a server 100, a grid management server 200, an electric power grid PG, a plurality of electrified vehicles 10, and an electric vehicle supply equipment (EVSE) 20. In FIG. 1, only one EVSE 20 is illustrated, but a plurality of EVSEs 20 may be provided. Further, the electric power grid PG is an example of the “electric power network” in the present disclosure.

The electric power grid PG is an electric power network that is built by unillustrated electric power plants and electricity transmission and distribution facilities. In the embodiment, an electric power company serves as both an electricity generation utility and an electricity transmission and distribution utility. The electric power company corresponds to a general electricity transmission and distribution utility, and maintains and manages the electric power grid PG. The electric power company corresponds to an administrator of the electric power grid PG.

The grid management server 200 manages electric power supply and demand in the electric power grid PG (electric power network). Further, the grid management server 200 belongs to the electric power company. The grid management server 200 sends a request (electric power supply-demand adjustment request) for adjusting the electric power demand amount of the electric power grid PG, to the server 100, based on the generated electric power and consumed electric power by each electric power adjustment 10 resource that is managed by the grid management server 200.

The server 100 is a server that is managed by an aggregator. The aggregator is an electricity utility that unifies a plurality of electric power adjustment resources in districts, predetermined facilities and the like, and that provides an energy management service. The server 100 manages electric power transmission (described later) for each of the plurality of electrified vehicles 10.

The server 100 requests the electrified vehicle 10 to performs the “electric power transmission”, as means for increasing or decreasing the electric power demand amount of the electric power grid PG. The electric power transmission is a control that includes the electricity supply (external electricity supply/external discharge) to the electric power grid PG and the charging (external charging) from the electric power grid PG. The server 100 sends a request signal for requesting the electric power transmission, to the electrified vehicle 10, a portable terminal (not illustrated) that is possessed by a user of the electrified vehicle 10, or the like. The electrified vehicle 10 may be configured to be capable of performing only one of the external electricity supply and the external charging. 25

The request for the electric power transmission includes information about an hour zone (a meeting period during which the electric power supply-demand adjustment request can be met) that is requested for the execution of the electric power transmission, and information about a requested charge (discharge) amount (agreed amount) in the above hour zone. In response to the above request, to the server 100, the user of each electrified vehicle 10 returns the intention about whether to meet the electric power supply-demand adjustment request (demand response), and in the case of meeting the electric power supply-demand adjustment request, returns information about an electric power amount by which the charging (discharging) can be performed by the user. The user may send information about an hour zone in the above hour zone (meeting period) during which the electric power supply-demand adjustment request can be met, to the server 100. In the present specification, it is assumed that all electrified vehicles 10 that meet the electric power supply-demand adjustment request can meet the electric power supply-demand adjustment request at any time in the above hour zone.

The electric power transmission is performed between the electrified vehicle 10 and the electric power grid PG through the EVSE 20. Examples of the electrified vehicle 10 include a plug-in hybrid electric vehicle (PHEV), a battery electric vehicle (BEV), and a fuel cell electric vehicle (FCEV).

The electrified vehicle 10 includes a battery 11 and a temperature sensor 12. By the electric power transmission, the charging to the battery 11 or the discharging from the battery 11 is performed. The temperature sensor 12 detects the temperature of the battery 11. The temperature sensor 12 may detect one of the temperature of the atmosphere around the battery 11, the temperature of a case (not illustrated) of the battery 11, and the temperature of a cell itself of the battery 11.

The EVSE 20 means a vehicle electricity supply equipment. The electrified vehicle 10 is configured to be capable of being electrically connected to the EVSE 20. For example, a charging cable 21 joined to the EVSE 20 is connected to an inlet of the electrified vehicle 10, and thereby electric power can be transferred between the EVSE 20 and the electrified vehicle 10.

Further, the server 100 is configured to manage information (also referred to as “vehicle information”, hereinafter) about registered electrified vehicles 10, information (also referred to as “user information”, hereinafter) about registered users, and information (also referred to as “EVSE information”, hereinafter) about registered EVSEs 20. The user information, the vehicle information, and the EVSE information are stored in a later-described memory 102, while being discriminated by identification information (ID).

A user ID is identification information for identifying the user, and functions also as information (terminal ID) for identifying the portable terminal (not illustrated) that is carried by the user. The server 100 is configured such that information received from the portable terminal (not illustrated) is saved while being discriminated for each user ID. The user information includes a communication address of the portable terminal (not illustrated) that is carried by the user, and a vehicle ID of the electrified vehicle 10 that belongs to the user.

The vehicle ID is identification information for identifying the electrified vehicle 10. The vehicle ID may be a number plate, or may be a vehicle identification number (VIN). The vehicle information includes the operation schedule of each electrified vehicle 10.

An EVSE ID is identification information for identifying the EVSE 20. The EVSE information includes a communication address of each EVSE 20 and the state of the electrified vehicle 10 that is connected to each EVSE 20. Further, the EVSE information includes information indicating the combination between the electrified vehicle 10 and the EVSE 20 that are connected to each other (for example, the combination between the EVSE ID and the vehicle ID).

The server 100 includes a processor 101, the memory 102, and a communication unit 103. The communication unit 103 is an example of the “acquisition unit” in the present disclosure.

In the memory 102, programs that are executed by the processor 101, and information (for example, maps, mathematical expressions, and various parameters) that is used in programs are stored. The communication unit 103 includes various communication I/Fs. The processor 101 controls the communication unit 103. The communication unit 103 communicates with at least one of the electrified vehicle 10, the EVSE 20, and the portable terminal (not illustrated) of the user.

The communication unit 103 acquires information relevant to the electric power transmission by the electrified vehicle 10 and the EVSE 20. Specifically, the communication unit 103 acquires information about between the electrified vehicle 10 and the EVSE 20 by which the electric power transmission is performed, as exemplified by a charge/discharge amount, a charging/discharging time, and an hour zone during which charging/discharging is performed.

The communication unit 103 acquires position information, speed information and others about the user, based on information from an unillustrated GPS module of the electrified vehicle 10, or the like. Further, the communication unit 103 receives, from the electrified vehicle 10, temperature information about the battery 11 that is detected by the temperature sensor 12.

The communication unit 103 receives air temperature information, weather information, traffic information, and the like, through an internet 300. The air temperature information, the weather information, the traffic information, and the like may include forecast (future information).

FIG. 2 is a diagram showing the relation between the upper limit of the transmitted electric power of the electrified vehicle 10 and the temperature of the battery 11. The transmitted electric power may be alternating-current power, or may be direct-current power. In the case where the transmitted electric power is alternating-current power, the ordinate axis in FIG. 2 indicates the amplitude of the alternating-current power.

As shown in FIG. 2, in the case where the temperature of the battery 11 is in the range of a temperature zone (referred to as a non-restrictive temperature zone, hereinafter) of 10° C. to 30° C., the upper limit of the transmitted electric power is not restricted (is not decreased). On the other hand, as the temperature of the battery 11 is more away from the non-restrictive temperature zone, the upper limit of the transmitted electric power is restricted (is decreased). In a temperature zone in which the temperature of the battery 11 is a constant value or more (for example, 25° C. or more) away from the non-restrictive temperature zone, the upper limit of the transmitted electric power may be constant. The above non-restrictive temperature zone is a temperature zone that is suitable for charging and discharging the battery 11. Further, the range of the non-restrictive temperature zone is not limited to the above example.

In the case where the electrified vehicle meets the electric power supply-demand adjustment request (demand response) in a state where the transmitted electric power is restricted, the transmitted electric power amount between the electrified vehicle and the electric power grid is sometimes unable to reach the agreed amount (the requested electric power amount based on the electric power supply-demand adjustment request) in the electric power supply-demand adjustment request.

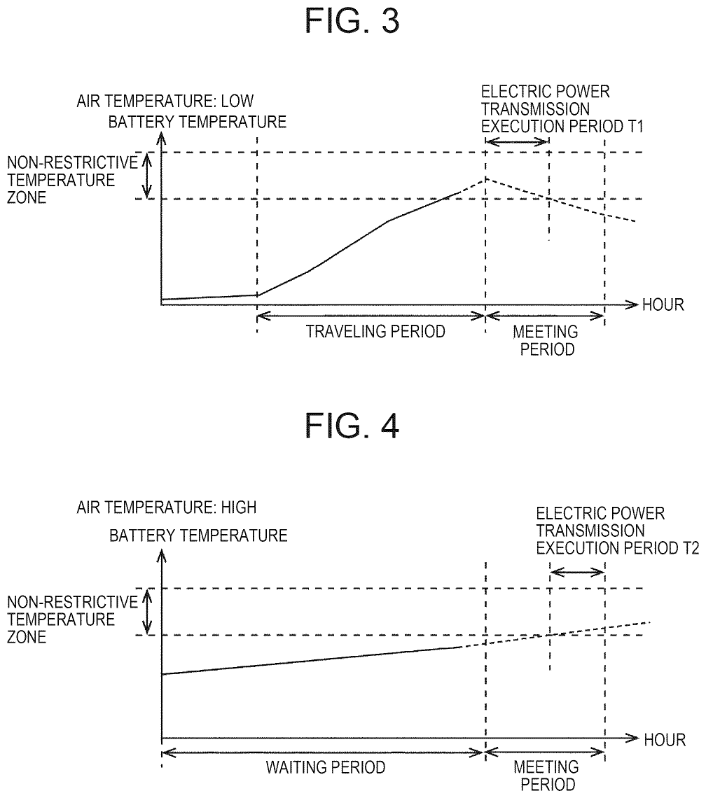

Hence, in the embodiment, the processor 101 estimates an hour zone that is in the meeting period for the electric power supply-demand adjustment request and during which the temperature of the battery 11 is in the range of the non-restrictive temperature zone, based on the temperature transition (see FIG. 3 and FIG. 4) of the battery 11. Then, based on the above estimated hour zone, the processor 101 sets an hour zone during which the electrified vehicle 10 executes the electric power transmission in response to the electric power supply-demand adjustment request.

FIG. 3 shows an example of a case where the electric power transmission is executed after the electrified vehicle 10 travels in a cold district in which the air temperature is low, or the like. In the example shown in FIG. 3, the transition of the temperature of the battery 11 from the past to the present is shown by a solid line, and the predicted value of the temperature of the battery 11 is shown by a broken line. The temperature of the battery 11 rises due to the traveling of the electrified vehicle 10. It is assumed that the temperature (predicted value) of the battery 11 is in the range of the non-restrictive temperature zone in a period T1 of the first half of the meeting period, as shown in FIG. 3. In this case, the period during which the electrified vehicle 10 executes the electric power transmission is set to the period T1. In the above example, the temperature transition of the battery 11 is predicted a predetermined time before the meeting period. However, the temperature transition of the battery 11 may be predicted just before the meeting period (or at the beginning of the meeting period).

FIG. 4 shows an example of a case where the electric power transmission is executed by the electrified vehicle 10 after waiting for a predetermined period in a district in which the air temperature is high, or the like. In the example shown in FIG. 4, the transition of the temperature of the battery 11 from the past to the present is shown by a solid line, and the predicted value of the temperature of the battery 11 is shown by a broken line. The temperature of the battery 11 gradually rises because the external air temperature is high. For example, it is assumed that the temperature of the battery 11 is in the range of the non-restrictive temperature zone in a period T2 of the second half of the meeting period, as shown in FIG. 4. In this case, the period during which the electrified vehicle 10 executes the electric power transmission is set to the period T2.

The processor 101 predicts the temperature transition of the battery 11 based on predetermined information. The above predetermined information includes the temperature information (current temperature) of the battery 11 that is detected by the temperature sensor 12.

Further, in the case where the electrified vehicle 10 travels before the electric power transmission is executed, the above predetermined information may include the distance (that is, the traveling distance) between the current place and a destination (the position of the EVSE 20 at which the electric power transmission is executed). Thereby, it is possible to predict the heat generation amount of the battery 11 due to the traveling of the electrified vehicle 10.

Further, the above predetermined information may include information about the transition of the air temperature in the section between the current place and the destination. The above transition of the air temperature includes at least one of the air temperature transition from the past to the present and the predicted value of the air temperature transition in the above section. Thereby, it is possible to predict the heat amount that the battery 11 receives from the external air, while the electrified vehicle 10 travels to the destination.

Further, the above predetermined information may include information about the transition of the air temperature at the destination. The above transition of the air temperature includes at least one of the air temperature transition from the past to the present and the predicted value of the air temperature transition at the destination. Thereby, it is possible to predict the heat amount that the battery 11 receives from the external air, while the electrified vehicle 10 stays at the destination (while the electrified vehicle 10 waits or executes the electric power transmission).

Further, the above predetermined information may include information about the temperature transition of the battery 11 from the past to the present. Thereby, it is possible to predict the temperature transition of the battery 11, based on the temperature transition of the battery 11 from the past to the present. Further, the above predetermined information may include information (for example, information about the actuation of air heating or air cooling in a predetermined hour zone) relevant to the operation schedule of the electrified vehicle 10. Thereby, it is possible to predict the heat generation amount of the battery 11 due to the scheduled operation of the electrified vehicle 10.

Further, the above predetermined information may include vehicle speed information about the electrified vehicle 10 and traffic information (congestion information) to the destination. Thereby, it is possible to predict the heat generation amount of the battery 11, based on the time to the arrival at the destination, or the like.

When the temperature transition of the battery 11 is predicted based on the above predetermined information, the processor 101 may use an after-learning model that is generated by the technology of machine learning such as deep learning, for example.

### Sequence of System

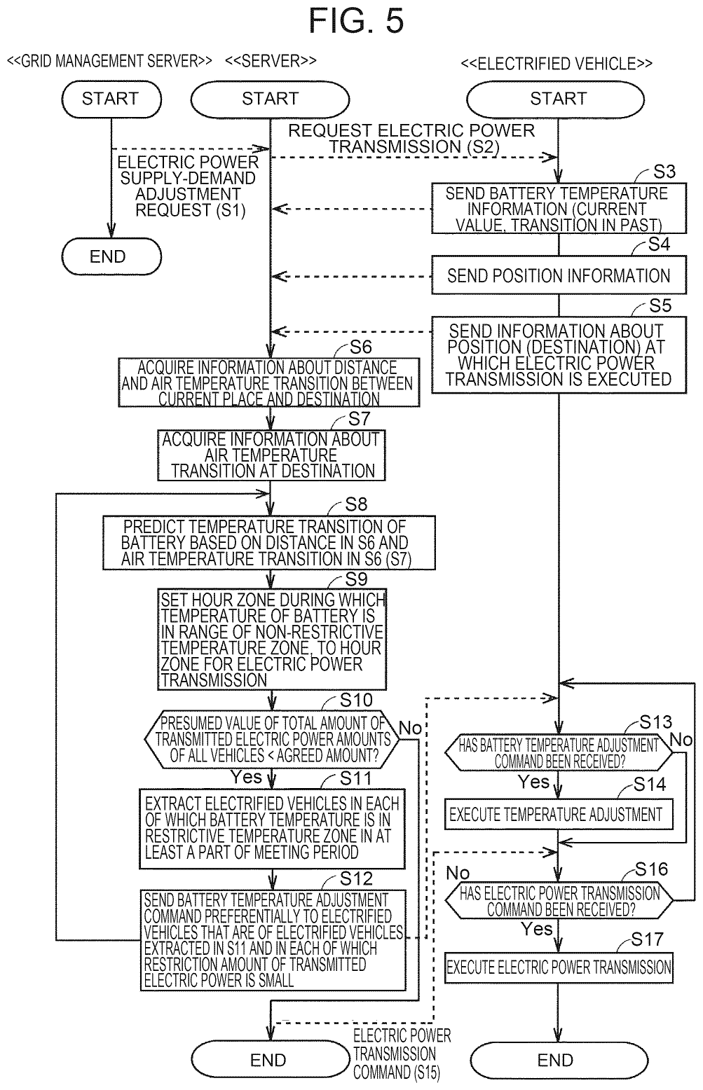

FIG. 5 is a diagram showing a sequence control by the system 1. In step S1, the grid management server 200 sends the electric power supply-demand adjustment request to the server 100. In step S2, the server 100 sends the request for the electric power transmission based on the electric power supply-demand adjustment request in step S1, to each of the plurality of electrified vehicles 10.

The electrified vehicle 10 that agrees to the request in step S2 sends information in step S3, information in step S4, and information in step S5, to the server 100. The order in which the information in step S3, the information in step S4, and the information in step S5 are sent to the server 100 is not limited to the example in FIG. 5.

In step S3, the electrified vehicle 10 sends the information relevant to the temperature of the battery 11, to the server 100. For example, the information relevant to the temperature of the battery 11 includes the information about the current temperature of the battery 11 and the information about the temperature transition of the battery 11 from the past to the present.

In step S4, the electrified vehicle 10 sends the position information (current place information) about the electrified vehicle 10 based on the unillustrated GPS module or the like, to the server 100.

In step S5, the electrified vehicle 10 sends the information about the position (destination) at which the electric power transmission is executed in response to the electric power supply-demand adjustment request, to the server 100. The information in step S5 may be registered in the server 100 (the memory 102), as information about a site at which the electrified vehicle 10 executes the electric power transmission.

In step S6, the server 100 (the processor 101) calculates the distance between the current place of the electrified vehicle 10 and the destination in step S5. Further, the server 100 (the communication unit 103) acquires the information about the air temperature transition (for example, the air temperature transition in the last one hour) in the section between the current place and the destination, for example, through the internet 300 or the like.

In step S7, the server 100 (the communication unit 103) acquires the information about the air temperature transition (for example, the air temperature transition in the last one hour) at the destination, for example, through the internet 300 or the like.

In step S8, the server 100 predicts the temperature transition of the battery 11, based on the temperature information in step S3, the information about the distance calculated in step S6, the information about the air temperature transition acquired in step S6, and the information about the air temperature transition acquired in step S7. Information such as the possible electricity storage capacity of the battery 11 and the kind of the battery 11 may be used for predicting the temperature transition of the battery 11.

In step S9, the server 100 calculates the hour zone during which the temperature of the battery 11 is in the range of the non-restrictive temperature zone, based on the temperature transition of the battery 11 that is predicted in step S8. Then, the server 100 sets the calculated hour zone, as the hour zone during which the electrified vehicle 10 executes the electric power transmission in response to the electric power supply-demand adjustment request.

In step S10, the server 100 determines whether a presumed value of the total amount (the total amount of the transmitted electric power amounts by the plurality of electrified vehicles 10) of the transmitted electric power amounts is smaller than the agreed amount in the electric power supply-demand adjustment request, based on the information about the hour zone for the electric power transmission by each of the plurality of electrified vehicles 10 that is set in step S9. In the case where the total amount of the transmitted electric power amounts is smaller than the agreed amount (Yes in S10), the process proceeds to step S11. In the case where the total amount of the transmitted electric power amounts is equal to or larger than the agreed amount (No in S10), the process proceeds to step S14.

In step S11, the server 100 extracts electrified vehicles 10 in each of which the temperature of the battery 11 is in a restrictive temperature zone (a temperature zone other than the non-restrictive temperature zone) in at least a part of the meeting period.

In step S12, the server 100 sends a battery temperature adjustment command preferentially to electrified vehicles 10 that are of the electrified vehicles 10 extracted in step S11 and in each of which the restriction amount of the transmitted electric power is small. Specifically, the server 100 sends the battery temperature adjustment command to the N top electrified vehicles 10 in the order from the electrified vehicle 10 in which the above restriction amount is smallest. Each of the above N and the temperature adjustment amount of the battery 11 may be a value that is calculated by the server 100 such that the determination condition in step S10 is satisfied (such that the determination of No is made), or may be a fixed value. Next, the process returns to step S8. For example, the restriction amount of the transmitted electric power may be an average value of the restriction amount in the time during which the temperature of the battery 11 is in the restriction temperature zone.

In step S13, the electrified vehicle 10 determines whether the battery temperature adjustment command corresponding to step S12 has been received. In the case where the battery temperature adjustment command has been received (Yes in S13), the process proceeds to step S14.

In step S14, the electrified vehicle 10 executes temperature adjustment based on the battery temperature adjustment command received in step S13. For example, the electrified vehicle 10 may increase or decrease the temperature of the battery 11, by switching the flowing path of a heat medium.

In step S15, the server 100 sends a command to execute the electric power transmission, to each electrified vehicle 10.

In step S16, the electrified vehicle 10 determines whether the electric power transmission command has been received from the server 100. In the case where the electric power transmission command has been received (Yes in S16), the process proceeds to step S17. In the case where the electric power transmission command has not been received (No in S16), the process returns to step S13. In step S17, the electrified vehicle 10 executes the electric power transmission in response to the command in step S15.

As described above, in the embodiment, the processor 101 estimates the hour zone that is in the meeting period for the electric power supply-demand adjustment request and during which the temperature of the battery 11 is in the range of the non-restrictive temperature zone, based on the predicted temperature transition of the battery 11. Then, based on the above estimated hour zone, the processor 101 sets the hour zone during which the electrified vehicle 10 executes the electric power transmission in response to the electric power supply-demand adjustment request. Thereby, it is possible to restrain the electric power transmission from being executed in an hour zone during which the transmitted electric power of the battery 11 is restricted. As a result, it is possible to restrain the transmitted electric power amount from the electrified vehicle from being unable to reach the agreed amount in the electric power supply-demand adjustment request.

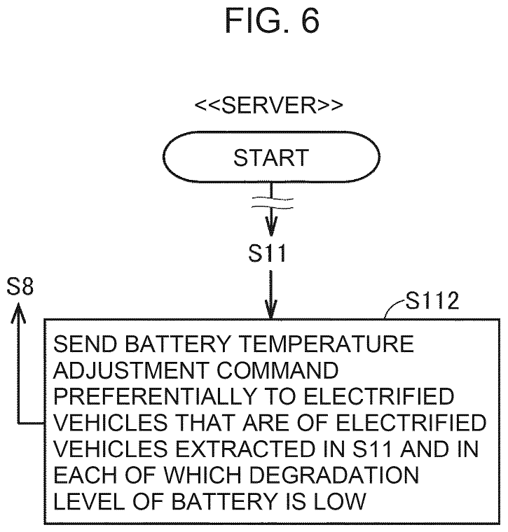

In the above embodiment, an example in which the battery temperature adjustment command is sent preferentially to electrified vehicles 10 in each of which the restriction amount of the transmitted electric power is small has been shown, but the present disclosure is not limited to this. For example, step S112 shown in FIG. 6 may be executed instead of step S12 in FIG. 5. In step S112, the server 100 sends the battery temperature adjustment command preferentially to electrified vehicles 10 that are of the electrified vehicles 10 extracted in step S11 and in each of which the degradation level (SOH: State of Health) of the battery 11 is low. Specifically, the server 100 sends the battery temperature adjustment command to the N top electrified vehicles 10 in the order from the electrified vehicle 10 in which the above degradation level is lowest.

In the above embodiment, an example in which the battery temperature adjustment command is sent to the N top electrified vehicles 10 in the order from the electrified vehicle 10 in which the restriction amount of the transmitted electric power is smallest has been shown, but the present disclosure is not limited to this. When the N top electrified vehicles 10 are selected, the electricity storage capacity of the battery 11 of the electrified vehicle 10 may be considered. For example, the battery temperature adjustment command may be sent to the N top electrified vehicles 10 in the order from the electrified vehicle 10 in which the restriction amount of the transmitted electric power is smallest, among electrified vehicles 10 in each of which the electricity storage capacity of the battery 11 is equal to or less than a predetermined threshold.

In the above embodiment, an example in which the hour zone during which the temperature of the battery 11 is in the range of the non-restrictive temperature zone of the transmitted electric power is set to the hour zone during which the electric power transmission is executed has been shown, but the present disclosure is not limited to this. For example, the electric power transmission may be executed in an hour zone during which the temperature of the battery 11 is in the range of the restrictive temperature zone (the temperature zone other than the non-restrictive temperature zone), as long as the electric power transmission is executed in at least a part of the hour zone during which the temperature of the battery 11 is in the range of the non-restrictive temperature zone.

In the above embodiment, an example in which the temperature transition of the battery 11 is predicted based on the distance between the current place and the destination, the transition of the air temperature between the current place and the destination, and the transition of the air temperature at the destination has been shown, but the present disclosure is not limited to this. The temperature transition of the battery 11 may be predicted based on some of the above three factors. None of the above three factors may be used. In this case, the temperature transition of the battery 11 is predicted based on only the temperature information about the battery 11.

In the above embodiment, an example in which the temperature adjustment command for the battery 11 is sent to some electrified vehicles 10 in which the transmitted electric power is restricted has been shown, but the present disclosure is not limited to this. It is allowable to adopt a configuration in which the temperature adjustment for the battery 11 is not performed. In this case, the total amount of the transmitted electric power amounts may be increased by executing the electric power transmission in at least a part (for example, an hour zone during which the restriction amount is smaller than a predetermined threshold) of the hour zone during which the transmitted electric power is restricted. That is, the threshold of the restriction amount of the transmitted electric power, that is, the threshold at which the execution of the electric power transmission is regulated, may be raised (relaxed).

It should be understood that the embodiments disclosed herein are examples and are not limitative in all respects. It is intended that the scope of the present disclosure is shown not by the above description of the embodiments but by the claims and includes all modification in meanings and ranges equivalent to the claims.

What is claimed is:

1. A server that manages electric power transmission capable of being performed by at least one electrified vehicle, the electric power transmission including at least one of charging from an electric power network and discharging to the electric power network, the server comprising:
an acquisition unit that acquires temperature information about a battery of the at least one electrified vehicle; and
a processor, wherein:
transmitted electric power in the electric power transmission is not restricted in a case where a temperature of the battery of the at least one electrified vehicle is in a range of a non-restrictive temperature zone; and
the processor
predicts a temperature transition of the battery in a meeting period based on at least the temperature information, the meeting period being a period during which an electric power supply-demand adjustment request from the electric power network is capable of being met,
estimates an hour zone in the meeting period based on the temperature transition, the hour zone being a period during which the temperature of the battery is in the range of the non-restrictive temperature zone, and
sets an hour zone during which the at least one electrified vehicle executes the electric power transmission in response to the electric power supply-demand adjustment request, based on the estimated hour zone.

2. The server according to claim 1, wherein the processor predicts the temperature transition of the battery based on at least one of a distance between a current place of the at least one electrified vehicle and a destination at which the electric power transmission is scheduled to be executed, a transition of air temperature between the current place and the destination, and a transition of the air temperature at the destination.

3. The server according to claim 1, wherein the processor performs a control to send a temperature adjustment command for the battery to the at least one electrified vehicle, in a case where a transmitted electric power amount in the electric power transmission by the at least one electrified vehicle is less than an agreed amount in the electric power supply-demand adjustment request and where the transmitted electric power of the at least one electrified vehicle is restricted in at least a part of the meeting period.

4. The server according to claim 3, wherein:
the at least one electrified vehicle includes a plurality of electrified vehicles in which the transmitted electric power is restricted;
for each of the plurality of electrified vehicles, a restriction amount of the transmitted electric power is larger as the temperature of the battery is more away from the non-restrictive temperature zone; and
the processor performs a control to send the temperature adjustment command preferentially to an electrified vehicle that is of the plurality of electrified vehicles and in which the restriction amount of the transmitted electric power is small.

5. The server according to claim 3, wherein:
the at least one electrified vehicle includes a plurality of electrified vehicles in which the transmitted electric power is restricted; and
the processor performs a control to send the temperature adjustment command preferentially to an electrified vehicle that is of the plurality of electrified vehicles and in which a degradation level of the battery is low.
